(19) United States
(12) Patent Application Publication
(10) Pub. No.: US 2026/0277604 A1
(43) Pub. Date: Sep. 17, 2026

(54) PROGRAM CREATION SUPPORT DEVICE AND PROGRAM PRODUCT

(71) Applicant: Keyence Corporation, Osaka (JP)

(72) Inventors: Shogo MATSUI, Osaka (JP); Keiya Shimomura, Osaka (JP)

(73) Assignee: Keyence Corporation, Osaka (JP)

(21) Appl. No.: 19/678,211

(22) Filed: May 15, 2026

Related U.S. Application Data
(63) Continuation of application No. PCT/JP2024/042873, filed on Dec. 4, 2024.

(30) Foreign Application Priority Data
Dec. 25, 2023 (JP) 2023-218361

(51) Int. Cl. G06F 8/73; G06F 8/74

(52) U.S. Cl. CPC G06F 8/73; G06F 8/74

(57) ABSTRACT

A work of adding a comment to a user program such as a ladder program is facilitated. A program creation support device receives, in a ladder program displayed on a first display unit, selection of a range to be converted into a program code in general-purpose programming language, converts the received range into the program code in the general-purpose programming language, generates a prompt in natural language for requesting summarization of the program code and control content of the program code, transmits the prompt to a large language model (LLM), receives a response statement, displays text included in the response statement, and adds, as a comment, at least a part of the text to the ladder program.

### CROSS-REFERENCE TO RELATED APPLICATIONS

The present application is a continuation of International Application No. PCT/JP2024/042873, filed Dec. 4, 2024, and claims foreign priority based on Japanese Patent Application No. 2023-218361, filed Dec. 25, 2023, the contents of which are incorporated herein by references.

### BACKGROUND OF THE INVENTION

### 1. Technical Field

The present invention relates to a program creation support device and a program product.

### 2. Description of the Related Art

A programmable logic controller (PLC) controls an actuator and a motor by a user executing a user program such as a ladder diagram (ladder language). When the user program is debugged or modified, the user needs to grasp the content of the user program. When time elapses after the program is written, or when a person who first described the user program is different from a person who intends to modify the user program, a huge amount of time is required for a work of grasping the user program.

JP6948450B describes that a user inputs a comment in natural language for every hierarchy to improve readability of a program.

Accordingly, it is expected that the work of grasping the user program can be easily performed.

Incidentally, input accuracy and completeness of a comment for the user program vary for every user. A comment with low input accuracy may conversely make the grasping work difficult. In addition, in a case where the completeness of the comment input is low, since there is no comment to be referred to, the grasping work becomes difficult. In addition, in a case where the user program is modified, a comment regarding the modification content may not be left or a wrong comment may be added. These cases also make it difficult to perform the work of grasping the user program. Therefore, it is required to appropriately and completely add the comment to the user program, but this work has not been easy.

### SUMMARY OF THE INVENTION

Therefore, an object of the present invention is to facilitate a work of adding a comment to a user program such as a ladder program.

The present invention provides, for example, a program creation support device that supports creation of a program used in a programmable logic controller, the program creation support device including: a first display unit that displays a ladder program; a reception unit that receives, in the ladder program displayed on the first display unit, selection of a range to be converted into a program code in general-purpose programming language; a first conversion unit that converts the range received by the reception unit into the program code in the general-purpose programming language; a prompt generation unit that generates a prompt in natural language for requesting summarization of the program code in the general-purpose programming language and control content of the program code; an LLM interface that transmits the prompt generated by the prompt generation unit to a large language model (LLM) and receives a response statement corresponding to the prompt from the large language model; a second display unit that displays text included in the response statement received via the LLM interface; and an editing unit that edits the ladder program to add, as a comment, at least a part of the text to the ladder program according to a user instruction.

According to the present invention, it is easy to add the comment to the user program such as the ladder program.

### BRIEF DESCRIPTION OF THE DRAWINGS

FIG. 1 is a diagram for explaining a PLC system;

FIG. 2 is a diagram for explaining a setting support device (program creation support device);

FIG. 3 is a diagram for explaining a basic unit;

FIG. 4 is a diagram illustrating functions of a CPU;

FIG. 5 is a sequence diagram illustrating a procedure from creation of a summary and the like to transfer of a user program;

FIG. 6 is a flowchart illustrating a procedure executed by the CPU;

FIG. 7 is a diagram for describing a user interface of setting software;

FIG. 8 is a diagram for describing an editing user interface of a device comment;

FIG. 9 is a diagram for describing a user interface for transmitting a prompt;

FIG. 10 is a diagram for describing a user interface for displaying a response statement;

FIG. 11 is a diagram for describing a user interface for displaying a ladder program reflecting a summary;

FIG. 12 is a diagram for describing another specific example;

FIG. 13 is a diagram for describing a prompt of another specific example;

FIG. 14 is a diagram for describing a response statement of another specific example;

FIG. 15 is a diagram for describing a prompt of another specific example;

FIG. 16 is a diagram for describing a response statement of another specific example;

FIG. 17 is a sequence diagram illustrating a procedure from creation of a summary and the like to transfer of a user program;

FIG. 18 is a flowchart illustrating a procedure executed by the CPU;

FIG. 19 is a diagram for describing a ladder program of another specific example; and

FIG. 20 is a diagram for describing a ladder program of another specific example reflecting a summary.

### DETAILED DESCRIPTION

Hereinafter, embodiments will be described in detail with reference to the accompanying drawings. Note that the following embodiments do not limit the invention according to the claims, and all combinations of features described in the embodiments are not necessarily essential to the invention. Two or more features of a plurality of features described in the embodiments may be arbitrarily combined. In addition, the same or similar configurations are denoted by the same reference numerals, and redundant description will be omitted.

### <PLC System>

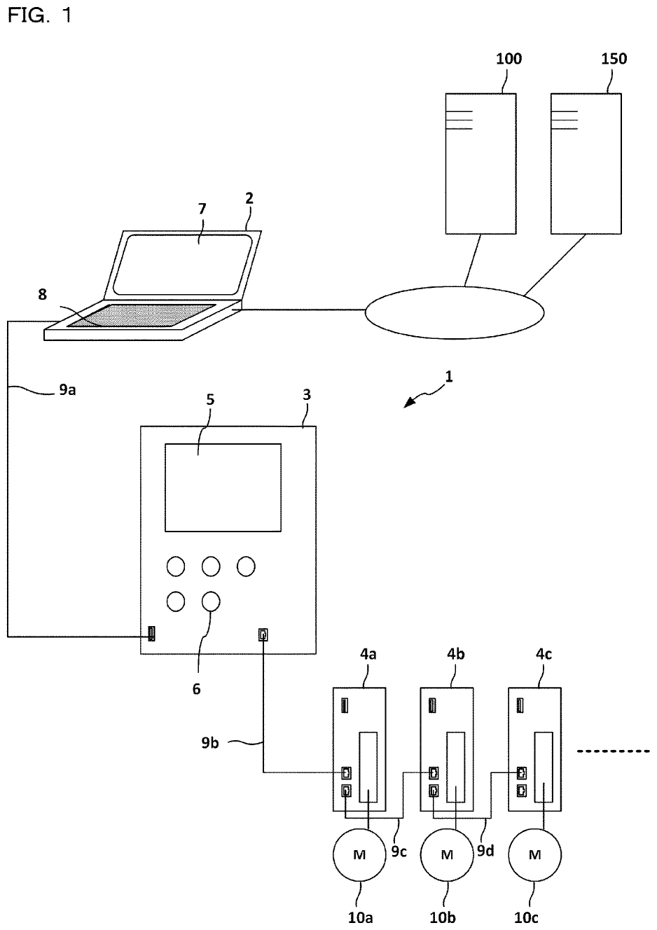

FIG. 1 illustrates a configuration example of a programmable logic controller system (hereinafter, referred to as a PLC system 1.) according to an embodiment of the present invention. As illustrated in FIG. 1, the PLC system 1 includes a PC that is a setting support device for editing a user program such as a ladder program, a basic unit 3 that is a programmable logic controller (PLC) for comprehensively controlling various control devices installed in a factory or the like, and a plurality of motor drivers 4a to 4c. The plurality of motor drivers 4a to 4c drives motors 10a, 10b, and 10c, respectively. The motor drivers 4a to 4c may be referred to as motor amplifiers or motion units. The motors 10a, 10b, and 10c drive loads as control targets.

A user program created by a PC 2, which is the setting support device, may be created by using a graphical programming language such as a ladder language, a flowchart-format motion program, or a structured text (ST) language, or may be created by using a high-level programming language such as C language.

In the PLC system 1, one or a plurality of extension units (example: I/O unit, analog input unit, analog output unit, communication unit, motor drivers 4a to 4c, and the like) are connected to the basic unit 3. The basic unit 3 may also be referred to as a CPU unit.

The basic unit 3 includes a display unit 5 and an operation unit 6. The display unit 5 can display operation statuses of the motor drivers 4a to 4c. The display unit 5 may switch a display content according to an operation content of the operation unit 6. The display unit 5 normally displays a current value (device value) of a device in the PLC system 1, error information (presence or absence of an alarm or warning) occurring in the PLC system 1, and the like. The device is a name indicating a region on a memory provided to store a device value (device data), and may be referred to as a data memory or a device memory. The device value is information indicating an input state from an input device, an output state to an output device, and states of an internal relay (auxiliary relay), a timer, a counter, a data memory, and the like set on the user program. Types of the device value include a bit type and a word type. A bit device stores a 1-bit device value. A word device stores a 1-word device value.

The motor drivers 4a to 4c are prepared to extend functions of the PLC system 1. The motors 10a to 10c are controlled by the motor drivers 4a to 4c, respectively. The motor drivers 4a to 4c supply power to the motors 10a to 10c, and control a rotation amount and the like according to a command from the basic unit 3. The motors 10a to 10c are, for example, servo motors, stepping motors, and the like.

The PC 2 is a computer that provides a development environment of the PLC system 1. The PC 2 is, for example, a portable notebook or tablet personal computer, and includes a display unit 7 and an operation unit 8. A ladder program, which is an example of the user program for controlling the PLC system 1, is created by using the PC 2. The created ladder program is converted into a mnemonic code in the PC 2. The PC 2 is connected to the basic unit 3 of the PLC system 1 via a communication cable 9a such as a universal serial bus (USB), and sends the ladder program converted into the mnemonic code to the basic unit 3. The basic unit 3 converts the ladder program into a machine code and stores the machine code in a memory included in the basic unit 3. Note that, although the mnemonic code is transmitted to the basic unit 3 here, the present invention is not limited thereto. For example, the PC 2 may convert the mnemonic code into an intermediate code, and transmit the intermediate code to the basic unit 3.

Note that, although not illustrated in FIG. 1, the operation unit 8 of the PC 2 may include a pointing device such as a mouse connected to the PC 2. In addition, the PC 2 may be configured to be detachably connected to the basic unit 3 via the communication cable 9a other than USB. In addition, the PC 2 may be wirelessly connected to the basic unit 3 without the communication cable 9a. In this case, the communication cable 9a may be understood to express a wireless link.

The basic unit 3 and the motor driver 4a are connected by a communication cable 9b, and can communicate with each other via the communication cable 9b. The motor driver 4a and the motor driver 4b are connected by a communication cable 9c, and can communicate with each other via the communication cable 9c. The motor driver 4b can communicate with the basic unit 3 via the communication cables 9b and 9c. The motor driver 4b and the motor driver 4c are connected by a communication cable 9d, and can communicate with each other via the communication cable 9d. In addition, the motor driver 4c can communicate with the basic unit 3 via the communication cables 9b, 9c, and 9d.

Hereinafter, the motor drivers 4a to 4c are referred to as the motor driver 4 in a case where common matters are described. Similarly, the motors 10a to 10c are referred to as the motor 10 in a case where common matters are described.

An LLM server 100 is, for example, a server computer or a service connected to the Internet. The PC 2 accesses the LLM server 100 via the Internet, transmits a prompt, and receives a response (response statement) to the prompt. The LLM server 100 has been machine-trained on a large number of source codes written in general-purpose programming languages represented by Python, Java, C++, JavaScript, C#, and the like. For example, when the PC 2 transmits, to the LLM server 100, a prompt which includes a desired program written in C language and related information thereof and requests a summary of the program, a response statement including the summary is received.

A database (DB) 150 is a server computer or a storage device that stores configuration information of the PLC system 1 and related information such as definition of a device used in the ladder program. The LLM server 100 may be constructed inside the PC 2, but the DB 150 may also be constructed inside the PC 2. When a query about an element of the code used in the program is received from the PC 2, the DB 150 searches for and extracts information (related information) associated with the element, and returns the related information to the PC 2. The DB 150 may store documentation such as a device handling manual or a ladder language manual of various types of PLC devices (example: basic unit, extension unit, display, motor amplifier, motor, and the like).

### <Setting Support Device>

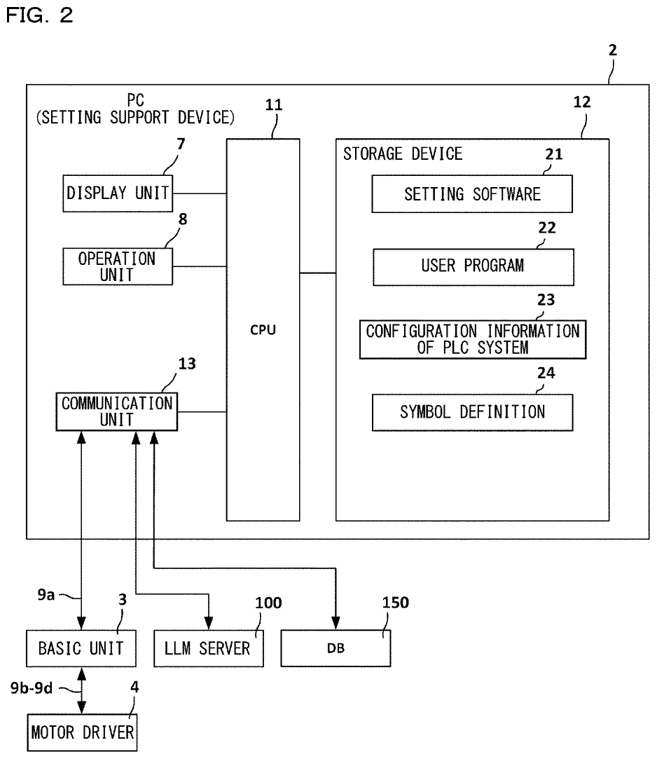

FIG. 2 is a block diagram for explaining an electrical configuration of the PC 2 operating as the setting support device. As illustrated in FIG. 2, the PC 2 includes a CPU 11, the display unit 7, the operation unit 8, a storage device 12, and a communication unit 13. The display unit 7, the operation unit 8, the storage device 12, and the communication unit 13 are electrically connected to the CPU 11. The storage device 12 includes a RAM, a ROM, an HDD, and an SSD, and may further include a detachable memory card. The CPU is an abbreviation for central processing unit. The ROM is an abbreviation for read-only memory. The RAM is an abbreviation for random-access memory. The HDD is an abbreviation for a hard disk drive. The SSD is an abbreviation for a solid state drive.

A user of the PC 2 causes the CPU 11 to execute setting software 21 stored in the storage device 12, edits a user program 22 through the operation unit 8, and transmits the user program 22 to the basic unit 3. In addition, the setting software 21 has a module that transmits a prompt to the LLM server 100, receives the response statement from the LLM server 100, and assists creation of the user program 22. The details thereof will be described later. The PC 2 may be referred to as an engineering tool or a program creation support device. The user program 22 is a ladder program, a motion program, or the like.

Configuration information 23 of the PLC system is information indicating connection positions of the plurality of motor drivers 4 with respect to the basic unit 3 and functions (example: communication function and positioning function) provided in the basic unit 3, information indicating a function and the like of the motor driver 4, and device assignment information. The user program 22 and the configuration information 23 of the PLC system are a part of project data. Here, the editing of the project data includes creation and change (re-editing) of the project data. The user reads the project data stored in the storage device 12 as necessary, and changes the project data by using the setting software 21.

Symbol definition 24 is a definition of various symbols (example: variables and devices) used in the PLC system 1. A template 25 is existing textual information used in creating a prompt to be sent to the LLM server 100.

The communication unit 13 communicates with the basic unit 3 via the communication cable 9a. The CPU 11 transfers the project data (such as the user program 22 and the configuration information 23) to the basic unit 3 via the communication unit 13. The communication unit 13 includes a communication circuit capable of executing communication conforming to the USB standard, a communication circuit that performs wired LAN communication, a communication circuit that performs wireless LAN communication, and the like.

The communication unit 13 communicates with the LLM server 100 and the DB 150 via a communication cable, the Internet, or a local network. A communication protocol between the PC 2 and the basic unit 3 may be a general-purpose protocol or a proprietary protocol.

### <Basic Unit>

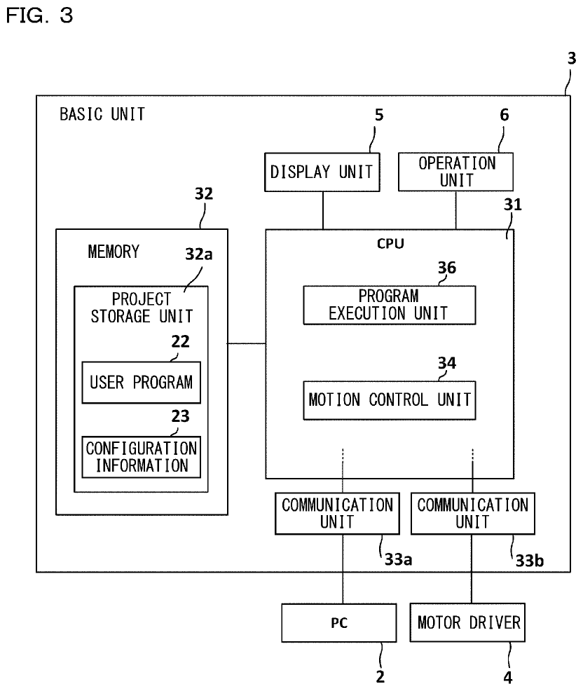

FIG. 3 illustrates a hardware configuration of the basic unit 3. A CPU 31 writes information in a memory 32 and reads information from the memory 32. The memory 32 includes a RAM, a ROM, an HDD, and an SSD, and may further include a detachable memory card. The project storage unit 32a is a ROM region that stores project data created and transferred by the PC 2. The project data includes the user program 22, the configuration information 23, and the like. Further, the CPU 31 receives an input of information from the operation unit 6. The CPU 31 displays various kinds of information on the display unit 5.

The CPU 31 is connected to the PC 2 via a communication unit 33a, and is connected to the motor driver 4 via a communication unit 33b to perform communication. The communication unit 33a is, for example, a communication circuit compatible with USB. The communication unit 33b is a communication circuit capable of executing communication compatible with the Industrial Ethernet Protocol (example: EtherCAT, EtherNet/IP, PROFINET, and MECHATROLINK-III).

A program execution unit 36 is an arithmetic processing circuit that executes the user program 22. The program execution unit 36 may be implemented on another CPU different from the CPU 31. The motion control unit 34 controls the motor driver 4 in cooperation with the program execution unit 36.

### <Editing of User Program>

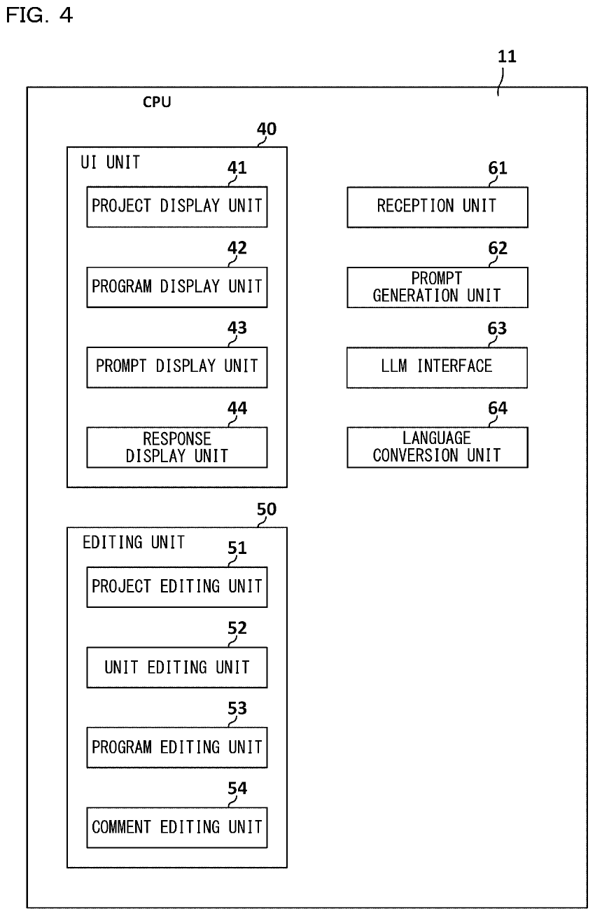

FIG. 4 illustrates some of various functions realized by the CPU 11 of the PC 2 executing the setting software 21. A UI unit 40 displays a user interface of the setting software 21 on the display unit 7. The UI unit 40 has various functions. A project display unit 41 displays a project name, program modules constituting a project, the configuration information 23, and the like on the display unit 7. A program display unit 42 displays, on the display unit 7, the user program 22 edited according to a user instruction received by a reception unit 61. A prompt display unit 43 displays, on the display unit 7, a prompt generated by a prompt generation unit 62 according to a user instruction received by the reception unit 61 and transmitted to the LLM server 100. A response display unit 44 displays the response statement received from the LLM server 100 on the display unit 7. Text included in the response statement can include an explanatory statement explaining logic in a range selected in the ladder program or an interpretation statement indicating interpretation of the logic.

An editing unit 50 edits the project data including the user program 22. A project editing unit 51 edits the project data in accordance with a user instruction received by the reception unit 61. A unit editing unit 52 edits the configuration information 23 indicating types of the basic unit 3, the extension unit (motor driver 4), and the like constituting the PLC system 1, a connection position of the extension unit, and the like according to a user instruction received by the reception unit 61. A program editing unit 53 edits the user program 22 according to a user instruction received by reception unit 61. A comment editing unit 54 edits a comment added to the user program 22 or the like according to a user instruction received by the reception unit 61.

The reception unit 61 receives, in the user program 22 displayed on the display unit 7, selection of a range to be converted into a program code in general-purpose programming language. For example, a part of the ladder program is designated by the user, and the designated part is converted into the program code in the general-purpose programming language by a language conversion unit 64. This range may be designated for every circuit block that is a minimum unit operable as the ladder program. This range may be designated for every group of a plurality of circuit blocks written in the ladder program. This range may be designated for every function block written in the ladder program.

A prompt generation unit 62 creates a prompt for requesting the LLM server 100 to create a summary or a comment for the part of the user program 22 designated by the user through the reception unit 61. For example, the prompt generation unit 62 may generate a prompt in natural language for requesting summarization of the program code in the general-purpose programming language and control content of the program code. The prompt generated by the prompt generation unit 62 can include, for example, at least one of a comment attached to an input and output element in the ladder program, information regarding a command or a program module in the ladder program, pieces of configuration information 23 of a plurality of units forming the programmable logic controller, a project name of a project including the ladder program, a module name of a program module included in the project, a point parameter used as movement coordinates of a control target in the motion unit controlled according to the ladder program, or setting information of variables written in the ladder program.

An LLM interface 63 controls the communication unit 13 to transmit the prompt generated by the prompt generation unit 62 to the LLM server 100 and receive a response statement corresponding to the prompt from the LLM server 100.

The language conversion unit 64 converts the range of the user program 22 received by the reception unit 61 into the program code in the general-purpose programming language.

The prompt generation unit 62 may generate a first prompt that instructs the LLM server 100 to perform element analysis of the program code. In this case, the LLM interface 63 receives a first response statement to the first prompt from the LLM server 100. The prompt generation unit 62 may access the DB 150 to acquire related information based on a result of the element analysis (example: device comment) included in the first response statement, and generate a second prompt including the related information. In this case, the LLM interface 63 transmits a second prompt to the LLM server 100, and receives a second response statement corresponding to the second prompt from the LLM server 100. The response display unit 44 may display text included in the second response statement received via the LLM interface 63 on the display unit 7.

The user program 22 may include a first ladder program and a second ladder program. The prompt generation unit 62 may create a prompt for requesting a summary of the first ladder program to obtain the first response statement, and create a prompt for requesting a summary of the second ladder program to obtain the second response statement. Further, the prompt generation unit 62 may generate a third prompt for instructing to summarize the first response statement and the second response statement. In this case, the LLM interface 63 can receive a third response statement to the third prompt from the LLM server 100. The response display unit 44 may display text included in the third response statement received via the LLM interface 63 on the display unit 7. The editing unit 50 may edit the user program 22 so as to add at least a part of the text included in the third response statement (example: entire summary of the user program 22) as a comment to the user program 22 according to a user instruction.

In a case where a size of the prompt including the program code in the general-purpose programming language exceeds a maximum size that can be input by the LLM server 100, the prompt generation unit 62 may divide the prompt into the first prompt and the second prompt. The LLM interface 63 may separately transmit the first prompt and the second prompt to the LLM server 100, and receive a first response statement corresponding to the first prompt and a second response statement corresponding to the second prompt.

The reception unit 61 may receive, in the program module displayed on the display unit 7, selection of the range to be converted into the program code in the general-purpose programming language. The language conversion unit 64 converts the range received by the reception unit 61 into the program code in the general-purpose programming language. The prompt generation unit 62 generates the prompt in natural language for requesting the summarization of the program code in the general-purpose programming language and the control content of the program code. The LLM interface 63 transmits the prompt generated by the prompt generation unit to the LLM server 100, and receives the response statement corresponding to the prompt from the LLM server 100. The response display unit 44 may display the text included in the response statement received via the LLM interface 63 on the display unit 7. The editing unit 50 edits the program module so as to add at least a part of the text as a comment to the program module according to a user instruction.

The response statement received from the LLM server 100 may include text suggesting that the LLM server 100 cannot create a comment only with the information provided by the prompt. In this case, the prompt generation unit 62 may generate a prompt including additional information input by the user and cause the LLM interface 63 to transmit the prompt. Accordingly, a possibility that a desired response statement is obtained can increase. Note that the text suggesting that the comment cannot be created only with the information provided by the prompt may include text indicating that a device comment for a specific device written in the ladder program is insufficient. The reception unit 61 and the comment editing unit 54 may receive an input of the device comment for the specific device. The prompt generation unit 62 may generate a prompt including the device comment as the additional information. Accordingly, the LLM server 100 generates a response statement based on the prompt including the device comment as the additional information.

The user cannot understand the content of the response statement. In this case, the prompt generation unit 62 may generate a prompt for asking the LLM server 100 a question about the content of a part of the response statement. Accordingly, the LLM server 100 creates a response statement to the question and transmits the response statement to the PC 2. The user can correctly understand the response statement by reading the response statement.

### <Sequence>

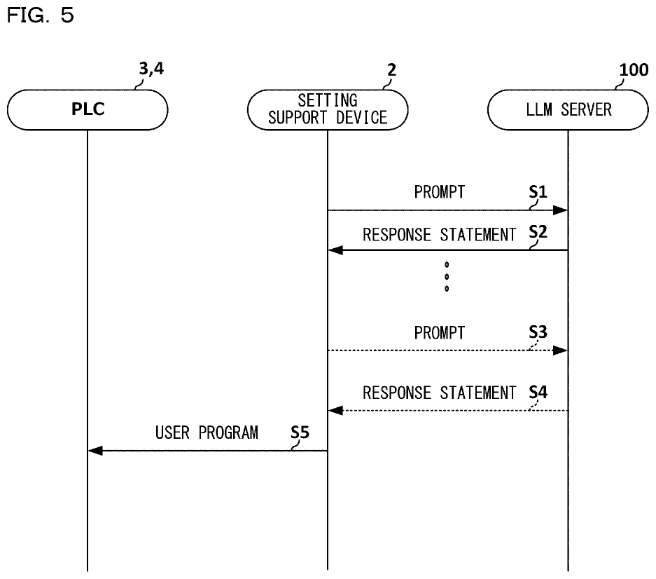

FIG. 5 illustrates a series of methods from the creation to the transfer of the user program 22.

In S1, the PC 2 creates a prompt based on the program code in the general-purpose programming language generated by the language conversion unit 64 from the range designated by the user in the user program 22 and related information thereof, and transmits the prompt to the LLM server 100. The LLM server 100 receives a prompt from the PC 2.

In S2, the LLM server 100 creates a response statement including a summary, a comment, an explanatory statement, interpretation statement, and the like of the program code in the general-purpose language according to the prompt, and transmits the response statement to the PC 2. The PC 2 receives the response statement from the LLM server 100.

The transmission and reception of the prompt in S3 and the transmission and reception of the response statement in S4 are optional. This is because the transmission and reception of the prompt and the response statement may be executed two or more times. As the user program 22 becomes more complicated, the number of times of the transmission and reception of the prompt and the response statement can increase. For example, the CPU 11 may create a prompt for every range of a plurality of user-designated ranges constituting the user program 22, and execute the transmission and reception of a prompt and a response statement for every designated range.

In S5, the PC 2 transfers the completed user program 22 to the PLC (the basic unit 3 or the motor driver 4). The program execution unit 36 of the basic unit 3 executes the user program 22.

### <Flowchart>

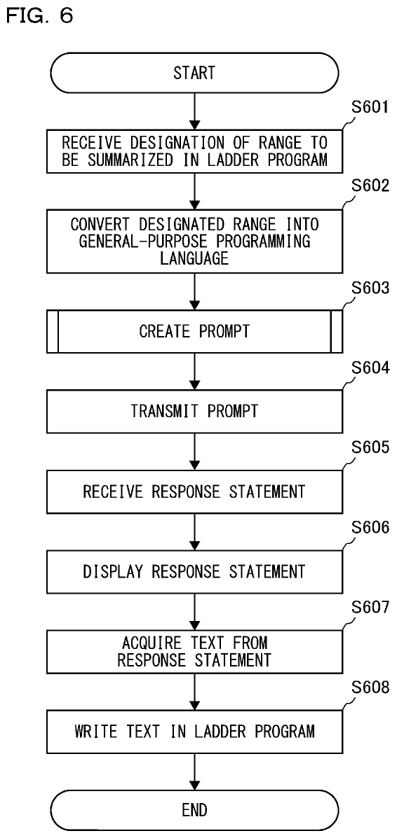

FIG. 6 illustrates a program editing work executed by the CPU 11 according to the setting software 21. Here, as an example, the ladder program is adopted as the user program 22.

In S601, the CPU 11 (reception unit 61) receives designation input by the user through the operation unit 8, that is, designation of a range to be summarized in the ladder program. Note that the summary is merely an example, and the designated range may be a detailed explanation of logic, interpretation of logic, or the like.

In S602, the CPU 11 (language conversion unit 64) converts the range designated by the user into the general-purpose programming language. In a case where the language conversion unit 64 supports a plurality of general-purpose programming languages, the reception unit 61 may receive selection of one general-purpose programming language from the user from the plurality of general-purpose programming languages. The language conversion unit 64 converts the designated range into the general-purpose programming language selected by the user.

In S603, the CPU 11 (prompt generation unit 62) creates a prompt including the program code in the general-purpose language generated by the language conversion unit 64. Here, the prompt generation unit 62 may include, as the additional information, the related information (example: device comment) of the program code in the prompt.

In S604, the CPU 11 (LLM interface 63) transmits the prompt created by the prompt generation unit 62 to the LLM server 100.

In S605, the CPU 11 (LLM interface 63) receives a response statement from the LLM server 100.

In S606, the CPU 11 (response display unit 44) displays the response statement received from the LLM server 100 on the display unit 7.

In S607, the CPU 11 (editing unit 50) acquires text such as a summary from the response statement based on a user instruction.

In S608, the CPU 11 (editing unit 50) writes the acquired text in the ladder program.

### <User Interface>

### (1) Editing UI of Project and User Program

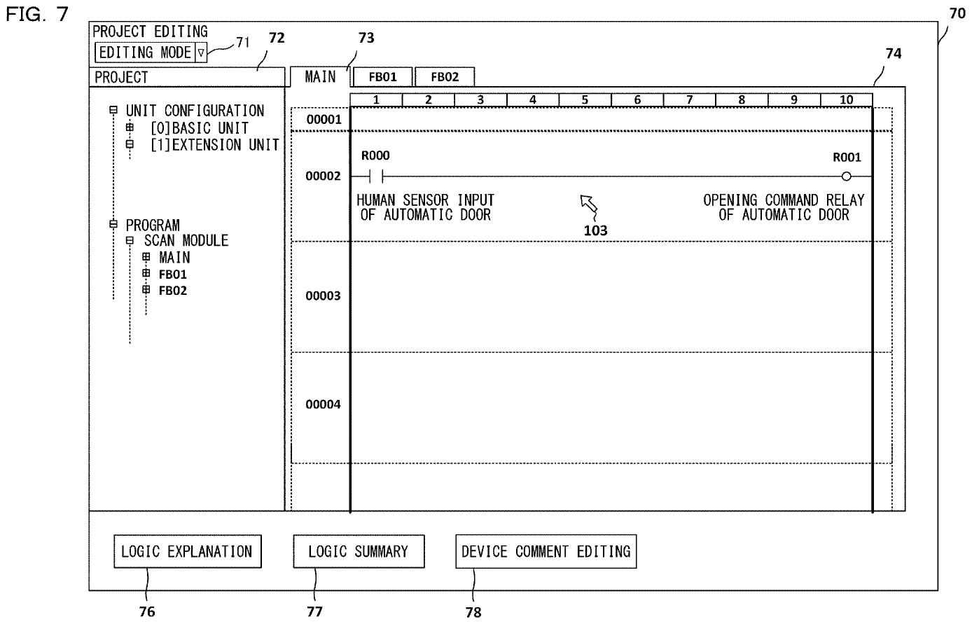

FIG. 7 illustrates an example of a user interface (UI) 70 of the setting software 21 (the UI 70 is displayed on the display unit 7 by executing the setting software 21). A mode selection menu 71 displays a plurality of modes included in the setting software 21 to be selectable. The plurality of modes includes an edit mode, a monitor mode, a replay mode (debug mode), and the like. The edit mode illustrated in FIG. 7 is a mode for editing the ladder program displayed in a program display region 74. The project display region 72 displays information constituting a project. Examples of the information include specification information and setting information of the basic unit 3 and the extension unit (motor driver 4) constituting the PLC system 1, device assignment information, setting information of an operation record, and a ladder program. In the edit mode, the program display region 74 displays the ladder program designated in the project display region 72 to be editable. In FIG. 7, a ladder program having a program module named as a main (example: every scan module) and a plurality of function blocks (FB01 and FB02) is displayed. In particular, a plurality of program modules is selectable by a tab 73, and in FIG. 7, the tab 73 corresponding to the main is selected.

As illustrated in FIG. 7, the ladder program is displayed as the ladder diagram. The ladder program is divided into a plurality of circuit blocks, and one line number is added to each circuit block. However, there may be a line in which a comment or the like is written without including the circuit block. According to FIG. 7, line 00001 is an empty line including no circuit block. Line 00002 writes two relay devices of R000 and R001. R000 is an input device, and R001 is an output device. Specifically, when R000 is turned on, R001 is also turned on, and an automatic door is opened. A device comment is added to each relay device in advance.

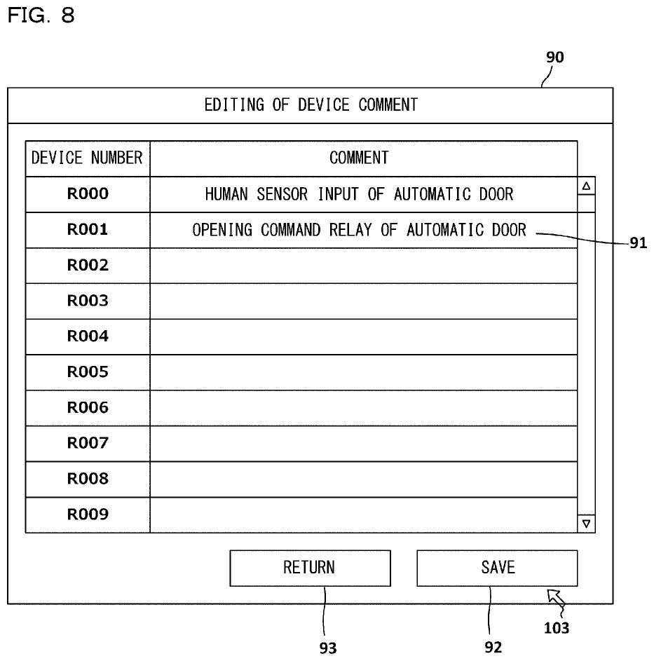

In a lower part of the UI 70, a logic explanation button 76, a logic summary button 77, and a device comment editing button 78 are provided. The user can operate a pointer 103 through the operation unit 8 to designate any line or operate any button. The logic explanation button 76 is a button for requesting the LLM server 100 to explain the logic in the designated range. The logic summary button 77 is a button for requesting the LLM server 100 to summarize the logic in the designated range. The device comment editing button 78 is a button for invoking a user interface (UI) (FIG. 8) for editing the comment of the device written in the ladder program.

### (2) Editing UI of Device Comment

FIG. 8 illustrates a device comment editing UI 90. A comment input field 91 receives an input of a comment for each of a plurality of devices written in the ladder program. In this example, “human sensor input of automatic door” is added as a comment to the relay device to which device number R000 is added. “Opening command relay of automatic door” is added as a comment to the relay device to which device number R001 is added. The user can operate the pointer 103 through the operation unit 8 to select the comment input field 91 and input a comment in the selected comment input field 91. When a save button 92 is pressed, the comment editing unit 54 saves the comment in the symbol definition 24. When a return button 93 is pressed, the UI unit 40 closes the device comment editing UI 90 and activates the UI 70. In a case where the comment is edited, the program display unit 42 updates the device comment added to the related device. Note that the relay device (bit device) is merely an example, and comments may be edited for a word device such as a data memory (DM), a buffer memory, and the like.

### (3) Confirm Prompt and Transmit UI

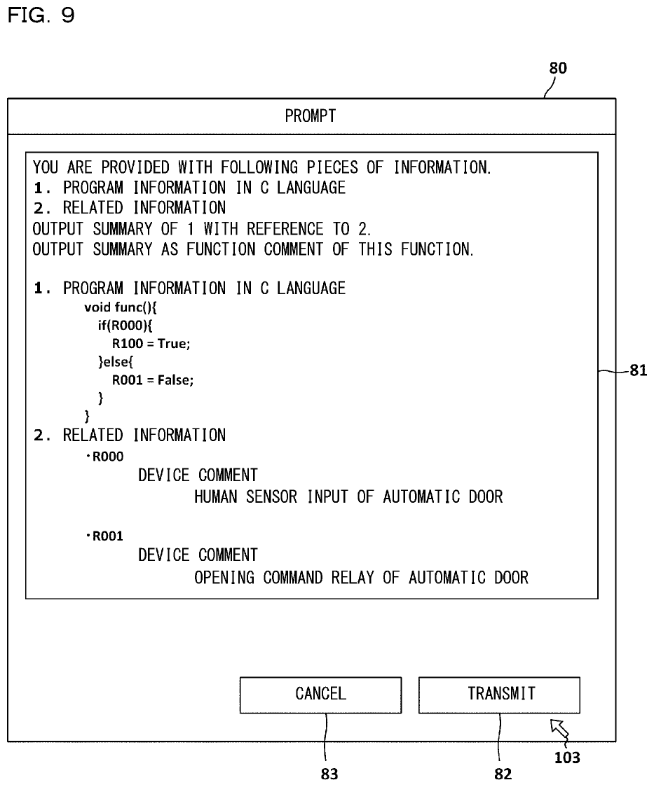

FIG. 9 illustrates a prompt UI 80 for displaying the prompt generated by the prompt generation unit 62. A prompt display region 81 displays a prompt. Here, as an example, the prompt displayed when the logic summary button 77 is pressed is shown.

The prompt of this example includes that program information in C language and related information are provided to the LLM server 100 and the summary for the program information in C language is to be created. The program information in C language is a program code generated by the language conversion unit 64 when the user designates the range of line 0002 illustrated in FIG. 7. The related information includes the device comment acquired by the prompt generation unit 62 from the symbol definition 24 for R000 and R001 that are included in the program information in C language generated by the language conversion unit 64. When a transmit button 82 is pressed, the LLM interface 63 transmits this prompt to the LLM server 100. When a cancel button 83 is pressed, the transmission of the prompt is canceled.

### (4) UI for Displaying Response Statement

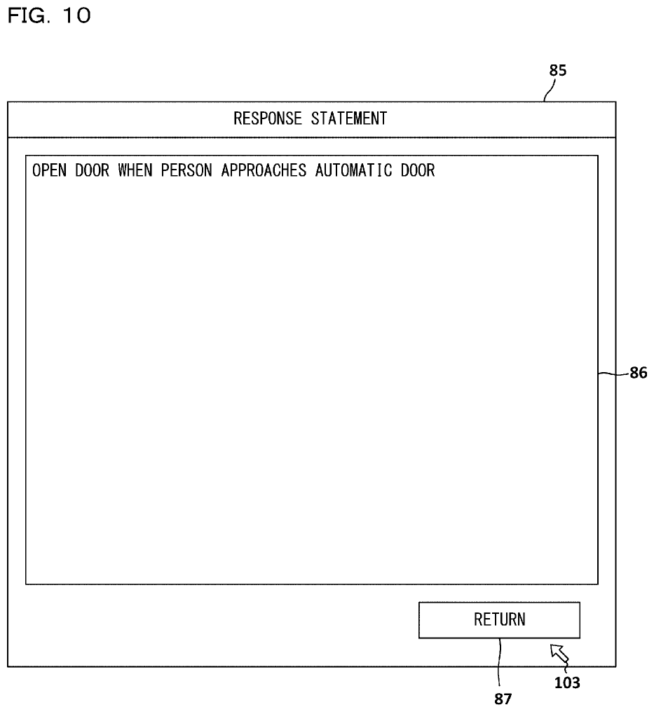

FIG. 10 illustrates a response display UI 85 displayed on the display unit 7 by the response display unit 44. The response statement received from the LLM server 100 is displayed in a response display region 86. The user can easily understand the content of the ladder program created by another person by reading the summary included in the response statement. Alternatively, it is possible to easily add a summary to the ladder program created by the user himself or herself or another person.

When the return button 87 is pressed, the CPU 11 closes the response display UI 85 and activates the UI 70. Note that, when the user confirms the summary displayed in the response display region 86, the user may select and copy the summary with the pointer 103 (that is, the summary is retained in a copy buffer). Accordingly, the user can paste the summary saved in the copy buffer to line 0001 (comment field) of the ladder program.
(5) Reflect Information Obtained from LLM Server in User Program

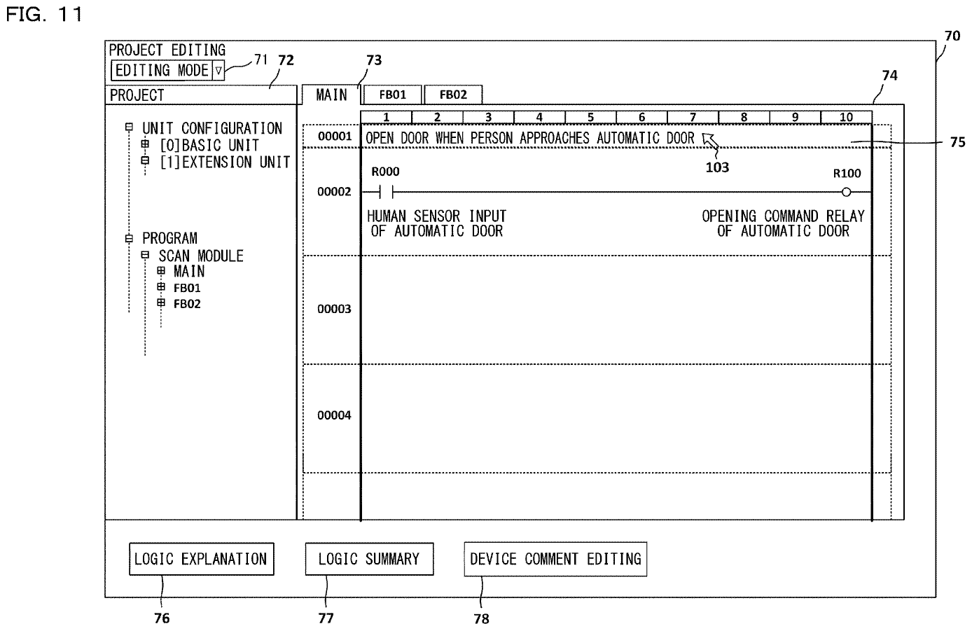

FIG. 11 illustrates the UI 70 displaying the user program 22 reflecting a summary 75 generated by the LLM server 100. The user selects line 0001 and pastes the summary 75 included in the response statement to line 0001. The editing unit 50 writes the summary 75 pasted on line 0001 into the ladder program (user program 22). Accordingly, when another user browses the ladder program, the user can immediately understand the summary 75 of the ladder program.

FIGS. 10 and 11 illustrate an example of the summary generated when the logic summary button 77 is pressed. In a case where the logic explanation button 76 is pressed, a response statement including explanation of logic such as “when human sensor input (R000) of the automatic door is turned on, opening command relay (R100) of the automatic door is turned on.” is obtained. Note that the summary may be a result of specifically interpreting the explanation of the logic.

### OTHER SPECIFIC EXAMPLES

### (1) First Specific Example

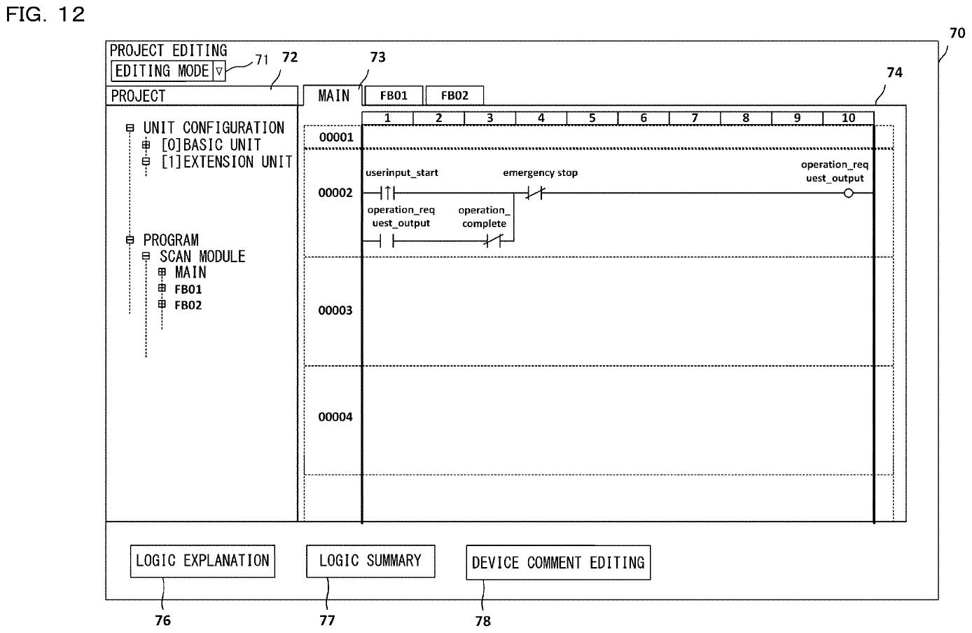

FIG. 12 illustrates an example of the UI 70 of the setting software 21. In the ladder program displayed in the program display region 74, when a relay device called userinput_start rises and a relay device called emergency_stop is off, a relay device called operation_request_output is on. Alternatively, when the relay device called operation_request_output is on, operation_complete is off, and the relay device called emergency_stop is off, the relay device called operation_request_output is on. That is, when operation_complete is not emergency_stop and userinput_start is on or operation_request_output is on and operation_complete is off, loop processing is continued.

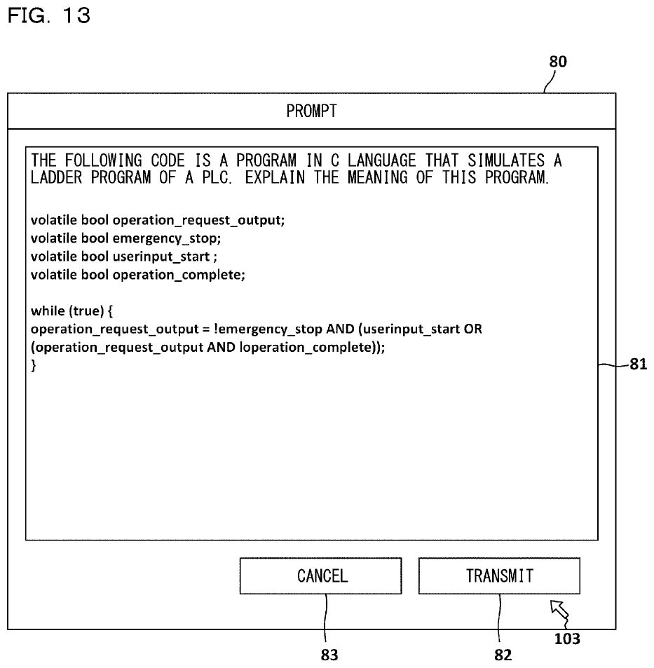

FIG. 13 illustrates the prompt created when the logic explanation button 76 is pressed. This example shows that line 0002 is designated by the pointer 103 and line 0002 is converted to generate the program code in C#. In this example, operation_request_output, userinput_start, and operation_complete are defined as bool type variables. In addition, as long as the condition described in connection with FIG. 12 is true, the while statement writes that a loop should continue. In addition, the prompt generation unit 62 starts with an instruction “the following code is a program in C language that simulates a ladder program of a PLC. Explain the meaning of this program.”

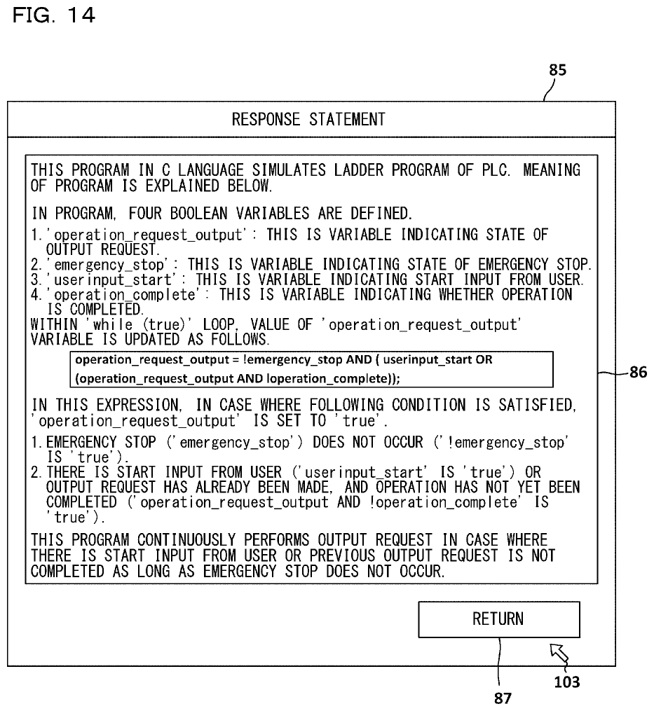

FIG. 14 illustrates an example of the response statement. According to this example, the response statement includes the program in C language simulating the ladder program of the PLC and a detailed explanation of the program. For example, it is described that four Boolean variables are defined, operation_request_output is a variable indicating a state of an output request, emergency_stop is a variable indicating a state of emergency stop, userinput_start is a variable indicating a start input from the user, operation_complete is a variable indicating whether the operation is completed, and a value of operation_request_output is updated as follows in while (true) loop. A detailed description of the update includes setting operation_request_output to true in a case where an expression in the while (true) loop satisfies the following condition. That is, the condition is that the emergency stop (emergency_stop) has not occurred (!emergency_stop is true), there is a start input from the user (userinput_start is true), or an output request has already been made, and the operation has not yet been completed (operation_request_output AND !operation_complete is true). In addition, it is also described that this program continuously performs an output request in a case where there is a start input from the user or a previous output request is not completed as long as the emergency stop does not occur.

As described above, it is possible to obtain a detailed explanation of the logic of the ladder program in the range designated by the user.

### (2) Second Specific Example

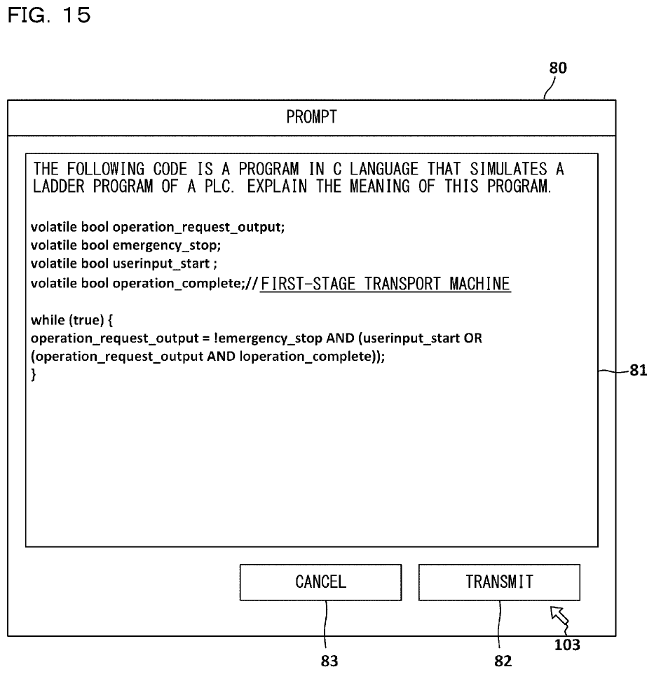

FIG. 15 illustrates a prompt generated for another specific example. Note that a ladder program of the second specific example is the same as the ladder program of the first specific example. Here, in the symbol definition 24, operation_request_output is assigned to a positioning start signal of axis 3 of the motor driver 4 which is the motion unit. In addition, the configuration information 23 includes “first-stage transport machine” as a comment for axis setting of axis 3.

The prompt generation unit 62 acquires that operation_request_output is assigned to the positioning start signal of axis 3 of the motor driver 4, which is the motion unit, in the symbol definition 24 for operation_complete included in a program code in C language generated from the designated range of the ladder program. Further, the prompt generation unit 62 acquires “first-stage transport machine” as a comment of the axis setting of axis 3 from the configuration information 23 about axis 3. As a result, the prompt generation unit 62 adds the comment “first-stage transport machine” to operation_complete as the additional information, and generates the prompt.

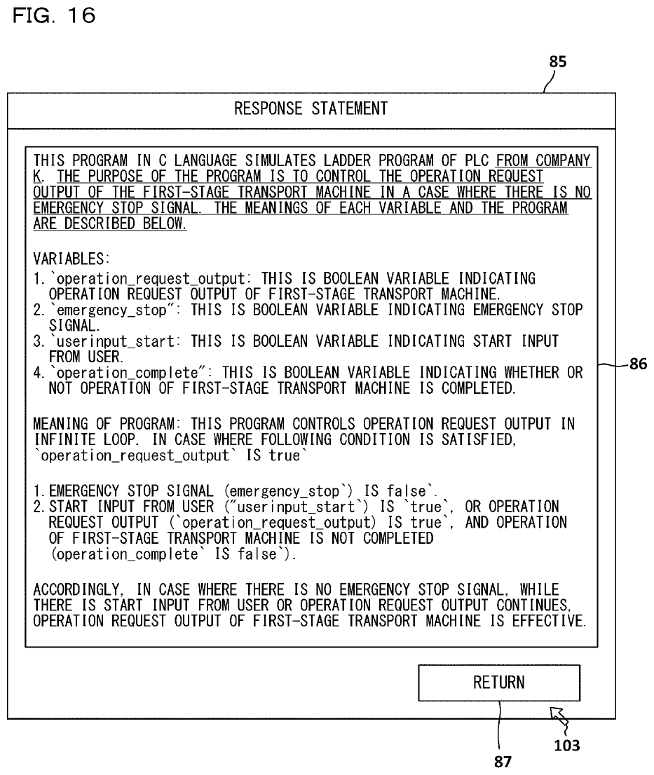

FIG. 16 illustrates an example of the response statement. In comparison with FIG. 14, in FIG. 16, a response statement to which additional information is added is obtained, such as “The purpose of the program is to control the operation request output of the first-stage transport machine in a case where there is no emergency stop signal. The meanings of each variable and the program are described below.” In addition, a specific response statement in which the additional information is added is also obtained for the explanation regarding the variable.

### <Modification>

### (1) Element Analysis

### (1-1) Sequence

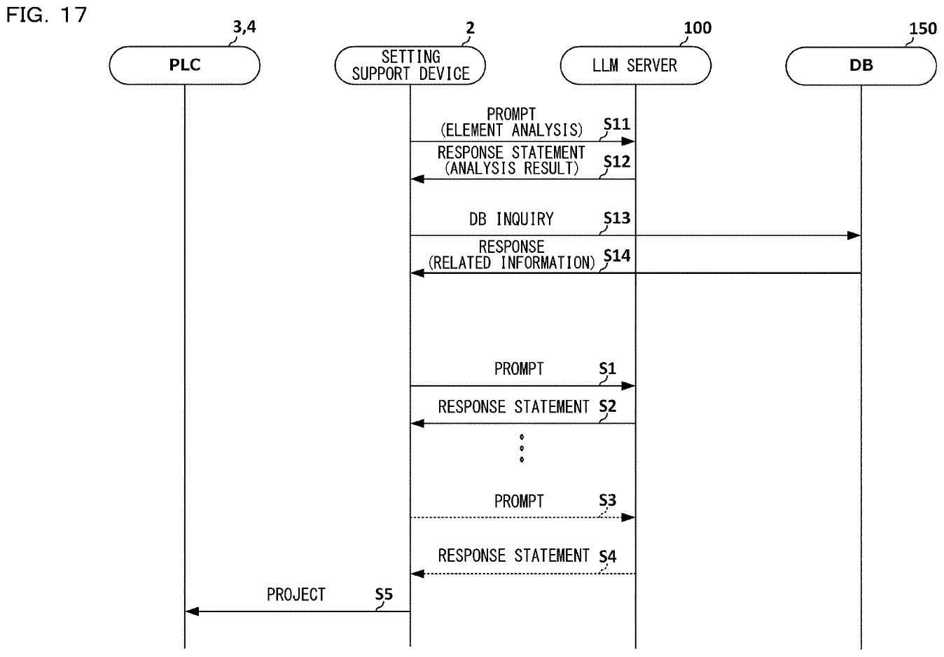

FIG. 17 illustrates a sequence of a modification. In this example, in order to create a prompt for requesting a summary or the like, the program code in the general-purpose programming language is subjected to element analysis in advance, and the related information of each element is acquired from the DB 150.

In S11, the PC 2 causes the language conversion unit 64 to convert the designated range of the ladder program to generate a mnemonic, creates a prompt for requesting element analysis for the mnemonic, and transmits the prompt to the LLM server 100. When the element analysis prompt is received, the LLM server 100 performs element analysis on the mnemonic included in the prompt. Accordingly, a response statement including an element analysis result is generated.

In S12, the LLM server 100 transmits the response statement to the PC 2. The PC 2 receives the response statement from the LLM server 100.

In S13, the PC 2 transmits a query to the DB 150 in order to acquire the related information of each element extracted from the response statement. When the query is received, the DB 150 searches for and extracts the related information of each element included in the query, and creates a search result including the extracted related information.

In S14, the DB 150 transmits a response including the related information to the PC 2. Thereafter, in S1, the PC 2 adds, as the additional information, the related information obtained from the DB 150 to the program code to create a prompt, and transmits the prompt to the LLM server 100. The following procedure is as already described.

### (1-2) Flowchart

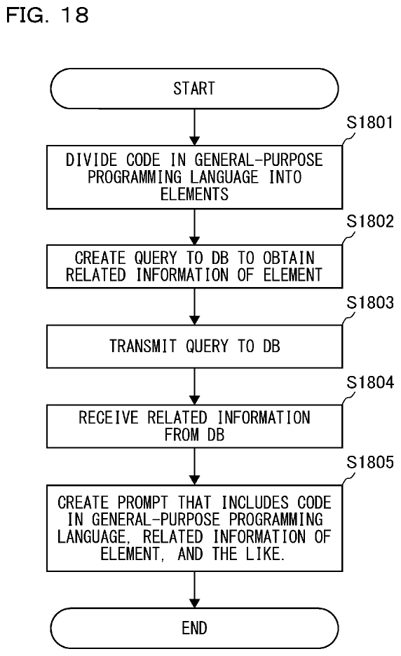

FIG. 18 illustrates an acquisition processing procedure of the related information executed by the CPU 11 according to the setting software 21. S1801 to S1802 illustrated in FIG. 18 may be executed, for example, as a part of S603 illustrated in FIG. 6. Here, after S601 and S602 are executed, the following processing is executed as a part of S603.

In S1801, the CPU 11 (prompt generation unit 62) performs the element analysis of the program code in the general-purpose programming language generated by the language conversion unit 64. Here, the analysis of the element may be executed by transmitting the prompt to the LLM server 100, or may be executed according to the setting software 21 in the PC 2.

In S1802, the CPU 11 (prompt generation unit 62) creates a query to the DB 150 to obtain the related information of the element acquired by the element analysis.

In S1803, the CPU 11 (prompt generation unit 62) controls the communication unit 13 to transmit the query to the DB 150.

In S1804, the CPU 11 (prompt generation unit 62) receives the related information for every element as a response to the query from the DB 150.

In S1805, the CPU 11 (prompt generation unit 62) adds the additional information (such as the related information of the element) to the code in the general-purpose programming language to create the prompt. Thereafter, the processing in and after S604 is executed.

### (2) Specific Examples

### (2-1) Ladder Program

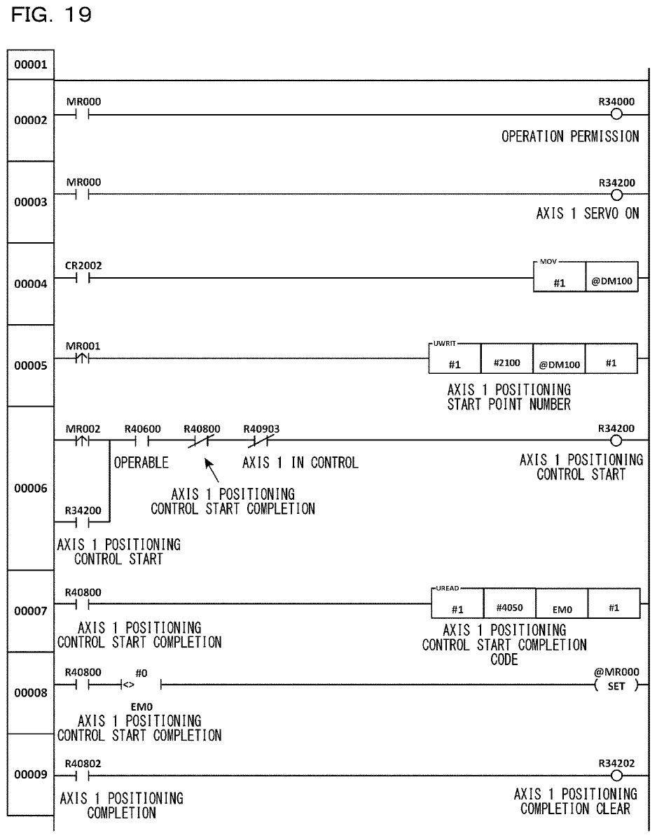

FIG. 19 illustrates an example of a ladder program that causes the motor driver 4 to execute 1-point operation. According to FIG. 19, when MR000 is turned on, the operation is permitted. In addition, when MR000 is turned on, the servo of axis 1 in motor driver 4 is turned on. CR2002 is a relay device that is always turned on. 3 is substituted into the DM100 by a MOV command. On the rising edge of MR001, 2100 is set as a positioning start point number of axis 1 by a UWRIT command. When MR002 rises, or when the positioning of axis 1 is started and the motor driver 4 is operable, and positioning control of axis 1 has not been started and axis control is not in process, the positioning control of axis 1 is started. When the positioning control start is completed, a completion code read by a UREAD command is written to EM0. Thereafter, after the start of the positioning control is completed, the positioning of axis 1 is completed.

It is assumed that the entire range of the ladder program illustrated in FIG. 19 is designated. In this case, the language conversion unit 64 may convert the designated range into a mnemonic. The following is an example of the mnemonic.
LD MR000
OUT R34000
LD MR000
OUT R34305
LD CR2002
MOV #1@DM100
LDP MR001
UWRIT #1 #2100 @DM100 #1
LDP MR002
OR R34200
AND R40600
ANB R40800
ANB R40903
OUT R34200
LD R40800
UREAD #1 #4050 EM0 #1
LD R40800
AND< > #0 EM0
SET @MR000
LD R40802
OUT R34202

### (2-2) Element Analysis Prompt

A prompt for requesting the LLM server 100 to perform element analysis for the above-described mnemonic is as follows.

```
“You are provided with the following pieces of information
1  Proprietary format
2  Proprietary program information
3  Output example for input example
1  Proprietary format
Command Space First argument Space Second argument Space
2  Proprietary program information
LD MR000
OUT R34000
LD MR000
OUT R34305
LD CR2002
MOV #1 @DM100
LDP MR001
UWRIT #1 #2100 @DM100 #1
LDP MR002
OR R34200
AND R40600
ANB R40800
ANB R40903
OUT R34200
LD R40800
UREAD #1 #4050 EMO #1
LD R40800
AND<> #0 EMO
SET @MR000
LD R40802
OUT R34202
3  Output example for input example
Input example
      LD R000
      OUT R100
Output example
      First command
      · LD
          First argument
            · R000
      Second command
      · OUT
          First argument
            · R100”
```

### (2-3) Response Statement for Element Analysis

The following is an example of the response statement received from the LLM server 100.

```
“First command
  Command: LD
  First argument: MR000
Second command
  Command: OUT
  First argument: R34000
Third command
  Command: LD
  First argument: MR000
Fourth command
  Command: OUT
  First argument: R34305
Fifth command
  Command: LD
  First argument: CR2002
Sixth command
  Command: MOV
  First argument: #1
  Second argument: @DM100
Seventh command
  Command: LDP
  First argument: MR001
Eighth command
  Command: UWRIT
  First argument: #1
  Second argument: #2100
  Third argument: @DM100
  Fourth argument: #1
Ninth command
  Command: LDP
  First argument: MR002
Tenth command
  Command: OR
  First argument: R34200
Eleventh command
  Command: AND
  First argument: R40600
Twelfth command
  Command: ANB
  First argument: R40800
Thirteenth command
  Command: ANB
  First argument: R40903
Fourteenth command
  Command: OUT
  First argument: R34200
Fifteenth command
  Command: LD
  First argument: R40800
Sixteenth command
  Command: UREAD
  First argument: #1
  Second argument: #4050
  Third argument: EM0
  Fourth argument: #1
Seventeenth command
  Command: LD
  First argument: R40800
Eighteenth command
  Command: AND<>
  First argument: #0
  Second argument: EM0
Nineteenth command
  Command: SET
  First argument: @MR000
Twentieth command
  Command: LD
  First argument: R40802
Twenty-first command
  Command: OUT
  First argument: R34202”
```

### (2-4) Acquisition of Related Information

Here, it is assumed that information having a high degree of relevance is extracted from the DB 150 regarding the second argument (#2100) of the UWRIT command, among a plurality of elements. A response from the DB 150 is as follows.

```
“// Sample program in case where operation of axis 1 is started in point operation No. 5
// Leading relay number R30000
// Leading DM number DM10000
// Axis 1 positioning control start relay R30200
// Axis 1 positioning control start completion relay R36800
// Axis 1 positioning completion relay R36802
// Axis 1 positioning completion clear relay R30202
//[Axis 1 positioning start point number] #2100
//[Axis 1 positioning control start completion code] #4050
void pointMove_zikul_point5( ){
  const int pointMoveNo = 5;
  if(MR000){
    R30000 = true;
    R30305 = true;
  }else{
    R30000 = false;
    R30305 = false;
}
if(!preMR001 && MR001){
  UWRIT(1, 2100, pointMoveNo, 1);
}
preMR001 = MR001;
if(((!preMR002 && MR002) ∥ R30200) && R36600 && R36800 && R36903){
  R30200 = true;
} else {
  R30200 = false;
}
preMR002 = MR002;
if(R36800){
  UREAD(1, 4050, EM0, 1);
}
if(R36800 && 0!=EM0){
  @MR000 = True;
}
if(R36802){
  R30202 = True;
}else{
  R30202 = False;
}
}”
```

### (2-5) Prompt for Requesting Summary or the Like

The following is an example of a prompt in which the related information based on the element analysis is added as the additional information.
“You are provided with the following pieces of information.
1. Program information in C language
2. Related information

Output a summary of 1 with reference to 2.

Output the summary as a function comment of this function.

```
1. Program information in C language
void func( ){
  if(MR000){
  R34000 = true;
  R34305 = true;
}else{
  R34000 = false;
  R34305 = false;
}
atDM100 = 1
if(!preMR001 && MR001){
  UWRIT(1, 2100, atDM100, 1);
}
preMR001 = MR001;
if(((!preMR002 && MR002) ∥ R34200) && R40600 && R40800 && R40903){
  R34200 = true;
} else {
  R34200 = false;
}
preMR002 = MR002;
if(R40800){
  UREAD(1, 4050, EM0, 1);
}
if(R40800 && 0!= EM0){
  @MR000 = True;
}
if(R40802){
  R34202 = True;
}else{
  R34202 = False;
  }
}
```

### 2. Related Information

```
// Sample program in case where operation of axis 1 is started in point operation No. 5
// Leading relay number R30000
// Leading DM number DM10000
// Axis 1 positioning control start relay R30200
// Axis 1 positioning control start completion relay R36800
// Axis 1 positioning completion relay R36802
// Axis 1 positioning completion clear relay R30202
//[Axis 1 positioning start point number] #2100
//[Axis 1 positioning control start completion code] #4050
void pointMove_ziku1_point5( ){
  const int pointMoveNo = 5;
  if(MR000){
    R30000 = true;
    R30305 = true;
  }else{
    R30000 = false;
    R30305 = false;
  }
if(!preMR001 && MR001){
  UWRIT(1, 2100, pointMoveNo, 1);
}
preMR001 = MR001;
if(((!preMR002 && MR002) ∥ R30200) && R36600 && R36800 && R36903){
  R30200 = true;
} else {
  R30200 = false;
}
preMR002 = MR002;
if(R36800){
  UREAD(1, 4050, EM0, 1);
}
if(R36800 && 0!= EM0){
  @MR000 = True;
}
if(R36802){
  R30202 = True;
}else{
  R30202 = False;
  }
}
```

2

### Special Device Comment

R34000 KV-16ML [1] Operation permission
R34200 KV-16ML [1] Axis 1 positioning control start
R34202 KV-16ML [1] Axis 1 positioning completion clear
R34305 KV-16ML [1] Axis 1 servo ON
R40600 KV-16ML [1] Operable
R40800 KV-16ML [1] Axis 1 positioning start completion
R40802 KV-16ML [1] Axis 1 positioning completion
R40903 KV-16ML [1] Axis 1 during axis control
   3

### Buffer Number

2100 Axis 1 positioning start point number
4050 Axis 1 positioning control start completion code
   4

### Point Parameters

### No1

50 cm in positive direction

### No2

25 cm in positive direction

### No3

10 cm in positive direction

### No4

10 cm in negative direction

### No5

50 cm in negative direction
   5

### Axis Configuration Information

### Axis 1

Slave type: SV2
Control tip of ball screw 1 in step 1

### Axis 2

Slave type: servo
Control tip of ball screw 3 in step 2”

Note that a special device comment is, for example, a comment acquired from the DB 150 and added to a special device.

### (2-6) Summary Included in Response Statement

An example of a response statement to the above prompt is as follows:

“The tip of ball screw 1 in step 1 controlled by SV2 is moved by 50 cm in a + direction”.

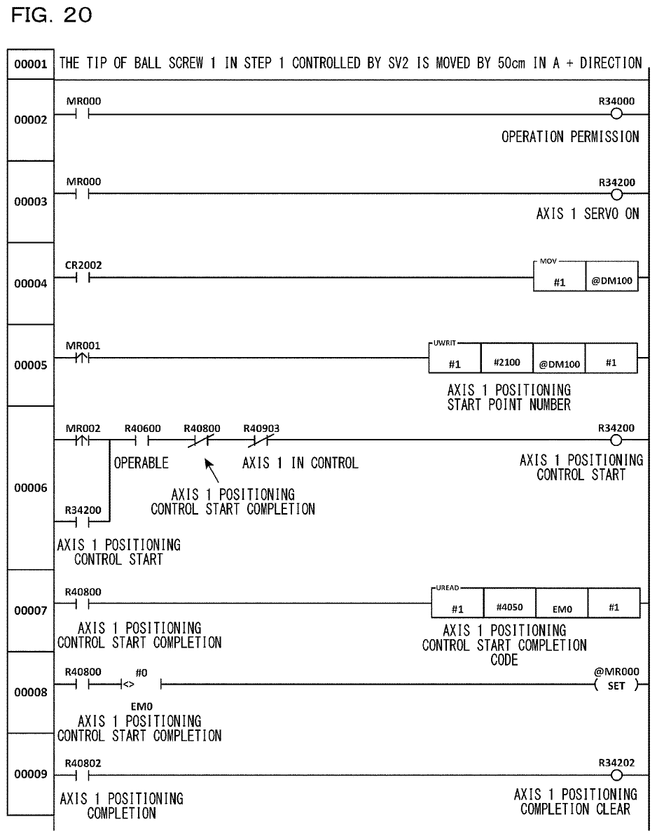

FIG. 20 illustrates an example in which a summary is added to line 0001. It can be seen that “The tip of ball screw 1 in step 1 controlled by SV2 is moved by 50 cm in a + direction”, which is the summary included in the response statement in line 0001, has been added.

<Technical Idea Derived from Examples>

### [Aspect 1]

The PC 2 is an example of the program creation support device that supports creation of the program used in the programmable logic controller. The CPU 11, the display unit 7, the program display unit 42, and the program display region 74 are examples of a first display unit that displays the ladder program. The CPU 11, the operation unit 8, and the reception unit 61 may receive, in the ladder program displayed on the first display unit, selection of the range to be converted into the program code in the general-purpose programming language. The CPU 11 and the language conversion unit 64 may function as a first conversion unit that converts the range received by the reception unit 61 into the program code in the general-purpose programming language. The CPU 11 and the prompt generation unit 62 may generate the prompt in natural language for requesting the summarization of the program code in the general-purpose programming language and the control content of the program code. The CPU 11, the communication unit 13, and the LLM interface 63 may function as an LLM interface that transmits the prompt generated by the prompt generation unit 62 to the large language model (LLM) and receives the response statement corresponding to the prompt from the large language model. The CPU 11, the display unit 7, the response display unit 44, and the response display UI 85 function as a second display unit that displays the text included in the response statement received via the LLM interface 63. The CPU 11 and the editing unit 50 may edit the ladder program to add, as the comment, at least a part of the text to the ladder program according to a user instruction. Accordingly, it is easy to add the comment to the user program such as the ladder program. Note that Generative artificial intelligence (AI) such as a Generative Pre-trained Transformer (GPT) is a kind of LLM, and evolution thereof is particularly remarkable recently. However, the generative AI is good at learning text in natural language, a program code in general-purpose programming language, and the like, but is not good at learning a ladder program. Therefore, the ladder program is converted into a program code in general-purpose programming language, and thus, a learning result of the program code in the general-purpose programming language can be used. The ladder program is an example, and the present embodiment can be useful for a user program written in graphical programming language for PLC, such as a motion flow.

### [Aspect 2]

The prompt may include at least one of the comment attached to the input and output element (example: input device and output device) in the ladder program, the information regarding the command or the program module (example: function block) in the ladder program, the configuration information of the plurality of units (example: basic unit and extension unit) forming the programmable logic controller, the project name of the project including the ladder program, the module name of the program module included in the project, the point parameter used as the movement coordinates of the control target in the motion unit (example: motor driver 4) controlled according to the ladder program, or the setting information (example: symbol definition 24) of the variable written in the ladder program. These pieces of information can be useful for the LLM server 100 in interpreting the program code. That is, the accuracy of obtaining the summary (example: outline of logic and detailed explanation of logic) of the program code can be improved.

### [Aspect 3]

The text included in the response statement may include the explanatory statement explaining the logic in the range selected in the ladder program. The user can easily understand the logic of the ladder program created by another person by reading the explanatory statement of the logic.

### [Aspect 4]

The text included in the response statement may include the interpretation statement indicating the interpretation of the logic included in the range selected in the ladder program. The user can easily understand the logic of the ladder program created by another person by reading the interpretation statement of the logic.

### [Aspect 5]

The prompt generation unit 62 may generate the first prompt that instructs the LLM server 100 to perform the element analysis of the program code. The LLM interface 63 may receive the first response statement to the first prompt from LLM server 100. The prompt generation unit 62 may acquire the related information based on the result of the element analysis included in the first response statement, and generate the second prompt including the related information. The LLM interface 63 may transmit the second prompt to the LLM server 100 and receive the second response statement corresponding to the second prompt from the LLM server 100. As illustrated in FIGS. 14 and 16, the second display unit (example: response display UI 85) may display the text included in the second response statement received via the LLM interface 63. As described above, the element analysis may be executed on the program code in the general-purpose programming language generated by converting the ladder program. Accordingly, the related information can be acquired from the DB 150 for every element. In addition, since the related information for every element is added as the additional information to the program code, the response statement including the more detailed summary and explanatory statement can be obtained.

### [Aspect 6]

The prompt generation unit 62 may access the database (example: DB 150) to acquire the related information based on the result of the element analysis included in the first response statement. The DB 150 may be implemented inside the PC 2.

### [Aspect 7]

The prompt generation unit 62 may determine whether or not a size of the prompt including the program code in the general-purpose programming language exceeds a maximum size (threshold) that can be input by the LLM server 100. In a case where the size of the prompt exceeds the threshold, the prompt generation unit 62 may divide the prompt into the first prompt and the second prompt. The LLM interface 63 may separately transmit the first prompt and the second prompt to the LLM server 100, and may receive the first response statement corresponding to the first prompt and the second response statement corresponding to the second prompt. Accordingly, the response statement can be acquired from the LLM server 100 even though the size of the program code is large.

### [Aspect 8]

As illustrated in FIG. 7, a range to be summarized or explained may be designated for every circuit block that is a minimum unit operable as the ladder program. For example, only line 00002 may be designated in the ladder program.

### [Aspect 9]

As suggested by FIG. 19, the range to be summarized or explained may be designated for every group of the plurality of circuit blocks written in the ladder program. For example, line 00002 to line 00009 may be collectively designated in the ladder program.

### [Aspect 10]

The range to be summarized or explained may be designated for every function block written in the ladder program. The range to be summarized or explained may be designated for every program module.

### [Aspect 11]

The reception unit 61 may receive, in the program module displayed on the first display unit (example: UI 70), the selection of the range to be converted into the program code in the general-purpose programming language. The first conversion unit (example: language conversion unit 64) may convert the range received by the reception unit 61 into the program code in the general-purpose programming language. The prompt generation unit 62 may generate the prompt in natural language for requesting the summarization of the program code in the general-purpose programming language and the control content of the program code. The LLM interface 63 may transmit the prompt generated by the prompt generation unit to LLM server 100 and receive the response statement corresponding to the prompt from the large language model. The second display unit (example: response display UI 85) may display the text included in the response statement received via the LLM interface 63. The editing unit 50 may edit the program module so as to add, as the comment, at least a part of the text to the program module according to the user instruction. As described above, the summary or the like may be generated for the specific program module among the plurality of program modules included in the project. For example, in a case where a plurality of program modules are independently created by a plurality of programmers, accuracy of adding a comment can vary. Therefore, variations in adding the comment can be reduced by using the invention according to the present embodiment.

### [Aspect 12]

The response statement may include the text suggesting that the LLM server 100 cannot create the comment only with the information provided by the prompt. In this case, the prompt generation unit 62 may generate the prompt including the additional information input by the user and cause the LLM interface 63 to transmit the prompt. Accordingly, it is easy to obtain a response statement as desired by the user.

### [Aspect 13]

The text indicating that the comment cannot be created only with the information provided by the prompt may include text indicating that the device comment for the specific device written in the ladder program is insufficient. The editing unit 50 may receive an input of the device comment for the specific device. For example, the CPU 11 can display, on the display unit 7, the device comment editing UI 90 for prompting the editing of the specific device comment, and can receive the input of the device comment. The prompt generation unit 62 may generate the prompt including the device comment as the additional information. The LLM interface 63 transmits the prompt to the LLM server 100, and receives the response statement from the LLM server 100. Accordingly, the response statement reflecting the specific device comment can be obtained.

### [Aspect 14]

The prompt generation unit 62 may generate the prompt for asking a question about the content of a part of the response statement. The user may not be able to understand the content of the response statement even after reading the response statement. In this case, the CPU 11 asks the LLM server 100 about the content of the response statement, and thus, a response statement that is easy for the user to understand can be obtained.

### [Aspect 15]

The setting software 21 is an example of a computer program that supports the creation of the program used by the programmable logic controller. The setting software 21 causes the computer to execute:
a first display step of displaying a ladder program;
a reception step of receiving, in the ladder program displayed in the first display step, selection of a range to be converted into a program code in general-purpose programming language;
a first conversion step of converting the range received in the reception step into the program code in the general-purpose programming language;
a prompt generation step of generating a prompt in natural language for requesting summarization of the program code in the general-purpose programming language and control content of the program code;
a transmission and reception step of transmitting the prompt generated in the prompt generation step to a large language model (LLM) and receiving a response statement corresponding to the prompt from the large language model;
a second display step of displaying text included in the response statement received from the large language model; and
an editing step of editing the ladder program so as to add, as a comment, at least a part of the text to the ladder program according to a user instruction.

### <Others>

In the embodiment described above, the summary is created for every designated range or program module of a part of the ladder program. However, the prompt generation unit 62 may create the prompt for requesting the LLM server 100 to summarize the entire project. In addition, in a case where the project is divided into a plurality of hierarchies, the prompt generation unit 62 may create a prompt for requesting the LLM server 100 to create a summary for every hierarchy. In the above-described embodiment, the designated range is set in units of lines, but the designated range may be set in units of functions.

The prompt generation unit 62 may create prompts individually for a plurality of different ladder programs and acquire response statements such as summaries for the plurality of ladder programs. Further, the prompt generation unit 62 may create a prompt for summarizing a plurality of response statements and obtain an overall summary of the plurality of response statements from the LLM server 100.

The invention is not limited to the above embodiments, and various modifications and changes can be made within the scope of the spirit of the invention.

What is claimed is:

1. A program creation support device for supporting creation of a program used in a programmable logic controller, the program creation support device comprising one or more memories configured to store executable units, and one or more processors, operatively coupled to the one or more memories, configured to execute the executable units, the executable units comprising:
a first display unit configured to display a ladder program;
a reception unit configured to receive, in the ladder program displayed on the first display unit, selection of a range to be converted into a program code in general-purpose programming language;
a first conversion unit configured to convert the range received by the reception unit into the program code in the general-purpose programming language;
a prompt generation unit configured to generate a prompt in natural language for requesting summarization of the program code in the general-purpose programming language and control content of the program code;
a large language model (LLM) interface configured to transmit the prompt generated by the prompt generation unit to an LLM and receive a response statement corresponding to the prompt from the LLM;
a second display unit configured to display text included in the response statement received via the LLM interface; and
an editing unit configured to edit the ladder program to add, as a comment, at least a part of the text to the ladder program according to a user instruction.

2. The program creation support device according to claim 1, wherein
the prompt includes at least one of
a comment attached to an input and output element in the ladder program;
information regarding a command or a program module in the ladder program;
configuration information of a plurality of units forming the programmable logic controller;
a project name of a project including the ladder program;
a module name of the program module included in the project;
a point parameter used as movement coordinates of a control target in a motion unit controlled according to the ladder program; or
setting information of a variable written in the ladder program.

3. The program creation support device according to claim 1, wherein the text included in the response statement includes an explanatory statement explaining logic in the range selected in the ladder program.

4. The program creation support device according to claim 1, wherein the text included in the response statement includes an interpretation statement indicating interpretation of logic included in the range selected in the ladder program.

5. The program creation support device according to claim 1, wherein
the prompt generation unit generates a first prompt for instructing the LLM to perform element analysis of the program code,
the LLM interface receives a first response statement to the first prompt from the LLM,
the prompt generation unit acquires related information based on a result of the element analysis included in the first response statement, and generates a second prompt including the related information,
the LLM interface transmits the second prompt to the LLM, and receives a second response statement corresponding to the second prompt from the LLM, and
the second display unit displays text included in the second response statement received via the LLM interface.

6. The program creation support device according to claim 5, wherein the prompt generation unit acquires, from a database, the related information based on the result of the element analysis included in the first response statement.

7. The program creation support device according to claim 1, wherein, in a case where a size of a prompt including the program code in the general-purpose programming language exceeds a maximum size capable of being input by the LLM, the prompt generation unit divides the prompt into a first prompt and a second prompt, and the LLM interface separately transmits the first prompt and the second prompt to the LLM, and receives a first response statement corresponding to the first prompt and a second response statement corresponding to the second prompt.

8. The program creation support device according to claim 1, wherein the range is designated for every circuit block that is a minimum unit operable as the ladder program.

9. The program creation support device according to claim 1, wherein the range is designated for every group of a plurality of circuit blocks written in the ladder program.

10. The program creation support device according to claim 1, wherein the range is designated for every function block written in the ladder program.

11. The program creation support device according to claim 1, wherein
the reception unit receives, in the program module displayed on the first display unit, the selection of the range to be converted into the program code in the general-purpose programming language,
the first conversion unit converts the range received by the reception unit into the program code in the general-purpose programming language,
the prompt generation unit generates a prompt in natural language for requesting summarization of the program code in the general-purpose programming language and control content of the program code,
the LLM interface transmits the prompt generated by the prompt generation unit to the LLM, and receives the response statement corresponding to the prompt from the LLM,
the second display unit displays the text included in the response statement received via the LLM interface, and
the editing unit edits the program module so as to add, as the comment, at least a part of the text to the program module according to a user instruction.

12. The program creation support device according to claim 1, wherein, in a case where the response statement includes text suggesting that the LLM is not capable of creating the comment only with the information provided by the prompt, the prompt generation unit generates a prompt including additional information input by a user, and causes the LLM interface to transmit the prompt.

13. The program creation support device according to claim 12, wherein
the text suggesting that the comment is not capable of being created only with the information provided by the prompt includes text indicating that a device comment for a specific device written in the ladder program is insufficient,
the editing unit receives an input of the device comment for the specific device, and
the prompt generation unit generates the prompt including the device comment, as the additional information.

14. The program creation support device according to claim 1, wherein the prompt generation unit generates a prompt for asking a question about a part of a content of the response statement.

15. A computer program product for supporting creation of a program used in a programmable logic controller, the computer program product having stored thereon instructions that, in response to execution, cause a device comprising one or more processors to perform operations, the operations comprising:
a first display step of displaying a ladder program;
a reception step of receiving, in the ladder program displayed in the first display step, selection of a range to be converted into a program code in general-purpose programming language;
a first conversion step of converting the range received in the reception step into the program code in the general-purpose programming language;
a prompt generation step of generating a prompt in natural language for requesting summarization of the program code in the general-purpose programming language and control content of the program code; and
a transmission and reception step of transmitting the prompt generated in the prompt generation step to a large language model (LLM) and receiving a response statement corresponding to the prompt from the LLM;
a second display step of displaying text included in the response statement received from the LLM; and
an editing step of editing the ladder program so as to add, as a comment, at least a part of the text to the ladder program according to a user instruction.

16. The computer program product according to claim 15, wherein the prompt generated in the prompt generation step includes at least one of:
a comment attached to an input and output element in the ladder program;
information regarding a command or a program module in the ladder program;
configuration information of a plurality of units forming the programmable logic controller;
a project name of a project including the ladder program;
a module name of the program module included in the project;
a point parameter used as movement coordinates of a control target in a motion unit controlled according to the ladder program; or
setting information of a variable written in the ladder program.

17. The computer program product according to claim 15, wherein:
the prompt generation step comprises generating a first prompt for instructing the LLM to perform element analysis of the program code,
the transmission and reception step comprises receiving a first response statement to the first prompt from the LLM,
the prompt generation step further comprises acquiring related information based on a result of the element analysis included in the first response statement, and generating a second prompt including the related information,
the transmission and reception step further comprises transmitting the second prompt to the LLM, and receiving a second response statement corresponding to the second prompt from the LLM, and
the second display step comprises displaying text included in the second response statement received from the LLM.

18. The computer program product according to claim 15, wherein, in a case where a size of the prompt including the program code in the general-purpose programming language exceeds a maximum size capable of being input by the LLM:
the prompt generation step comprises dividing the prompt into a first prompt and a second prompt, and
the transmission and reception step comprises separately transmitting the first prompt and the second prompt to the LLM, and receiving a first response statement corresponding to the first prompt and a second response statement corresponding to the second prompt.

19. The computer program product according to claim 15, wherein, in a case where the response statement includes text suggesting that the LLM is not capable of creating the comment only with the information provided by the prompt, the operations further comprise:
causing, by the prompt generation step, a prompt including additional information input by a user to be generated; and
causing, by the transmission and reception step, the prompt including the additional information to be transmitted to the LLM.

20. The computer program product according to claim 15, wherein the prompt generation step further comprises generating a prompt for asking a question about a part of a content of the response statement.
